(19) United States
(12) Patent Application Publication
(10) Pub. No.: US 2025/0217965 A1
(43) Pub. Date: Jul. 3, 2025

(54) BUSINESS OPERATION ASSISTANCE SYSTEM, BUSINESS OPERATION ASSISTANCE METHOD, AND STORAGE MEDIUM

(71) Applicants: NEC Corporation, Minato-ku, Tokyo (JP); NEC Solution Innovators, Ltd., Koto-ku, Tokyo (JP)

(72) Inventors: Yaeko YONEZAWA, Tokyo (JP); Kazunari HOSOI, Tokyo (JP)

(73) Assignees: NEC Corporation, Minato-ku, Tokyo (JP); NEC Solution Innovators, Ltd., Koto-ku, Tokyo (JP)

(21) Appl. No.: 18/851,274

(22) PCT Filed: Mar. 31, 2022
(86) PCT No.: PCT/JP2022/016437

§ 371 Date: Sep. 26, 2024

(51) Int. Cl. G06T 7/00; G06Q 10/087

(52) U.S. Cl. CPC G06T 7/001; G06Q 10/087

(57) ABSTRACT

An image acquisition means acquires images in which the product shelf is included. An image group information generation means generates a first image group information that includes the plurality of images. A comparison means makes a comparison between the first image group information item and the second image group information item that includes the reference image. A notification means provides notification when the image group information items are different from each other as a result of the comparison by the comparison means.

### TECHNICAL FIELD

The present invention relates to a business operation assistance system, a business operation assistance device, a business operation assistance method, and a storage medium.

### BACKGROUND ART

There is known a technique for generating information on a product displayed on a product shelf by photographing the product shelf arranged in a store or the like and analyzing the photographed image.

For example, PTL 1 discloses a technique of generating a shelf layout using a plurality of images including a product shelf photographed at different photographing positions.

### CITATION LIST

### Patent Literature

PTL 1: JP 2019-200697 A

### SUMMARY OF INVENTION

### Technical Problem

When generating shelf layout information by analyzing an image obtained by photographing a product shelf, defect related to the captured image may occur. Although there is no defect regarding the captured image, the layout of the product may be changed. In these cases, there is a problem that shelf layout analysis cannot be performed and it takes time to perform shelf layout analysis. Therefore, there is a demand for a technique for reducing the workload of shelf layout analysis.

Therefore, an object of the present invention is to provide a business operation assistance system, a business operation assistance device, a business operation assistance method, and a storage medium for acquiring images including a product shelf and making a comparison between a first image group information item including the plurality of acquired images and a second image group information item including a reference image and for providing notification when these image group information items are different from each other as a result of the comparison.

### Solution to Problem

An aspect of a business operation assistance system of the present invention includes: an image acquisition means for acquiring an image including a product shelf; an image group information generation means for generating a first image group information item including a plurality of the images; a comparison means for comparing the first image group information item with a second image group information item including a reference image; and a notification means for making a notification in a case where the image group information items are different as a result of comparison by the comparison means.

An aspect of a business operation assistance device of the present invention includes: an image acquisition means for acquiring an image including a product shelf; an image group information generation means for generating a first image group information item including a plurality of the images; a comparison means for comparing the first image group information item with a second image group information item including a reference image; and a notification means for making a notification in a case where the image group information items are different as a result of comparison by the comparison means.

An aspect of the business operation assistance method of the present invention includes: acquiring an image including a product shelf; generating a first image group information item including a plurality of the images; comparing the first image group information item with a second image group information item including a reference image; and making a notification in a case where the image group information items are different as a result of the comparing.

An aspect of a computer-readable storage medium that stores a program of the present invention causes a computer to execute: acquiring an image including a product shelf; generating a first image group information item including a plurality of the images; comparing the first image group information item with a second image group information item including a reference image; and making a notification in a case where the image group information items are different as a result of the comparing.

### Advantageous Effects of Invention

According to the present invention, it is possible to reduce the workload of shelf layout analysis.

### BRIEF DESCRIPTION OF DRAWINGS

FIG. 1 is a block diagram illustrating an example of a configuration of a business operation assistance system according to a first example embodiment.

FIG. 2 is a flowchart illustrating an example of an operation of the business operation assistance system according to the first example embodiment.

FIG. 3 is an example of displaying a region having an insufficient imaging region in an identifiable manner.

FIG. 4 is a flowchart illustrating an example of an operation of the business operation assistance system according to a second example embodiment.

FIG. 5 is a flowchart illustrating an example of an operation of the business operation assistance system according to the second example embodiment.

FIG. 6 is a block diagram illustrating a hardware configuration of an information processing device capable of configuring each component in each example embodiment.

### EXAMPLE EMBODIMENTS

### First Example Embodiment

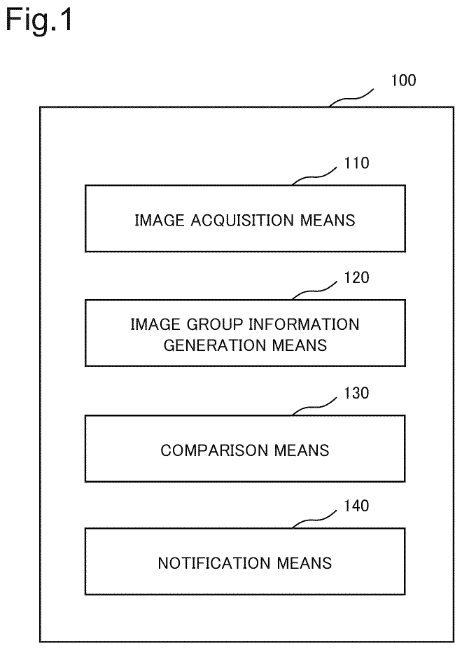

FIG. 1 illustrates a configuration example of a business operation assistance system 100 according to a first example embodiment of the present invention.

The business operation assistance system 100 includes an image acquisition means 110, an image group information generation means 120, a comparison means 130, and a notification means 140. In FIG. 1, each block included in the business operation assistance system 100 shows a configuration in units of function. Therefore, each block included in the business operation assistance system 100 illustrated in FIG. 1 may be mounted in a single business operation assistance device, or may be separately mounted in a plurality of devices.

The image acquisition means 110 acquires an image including a product shelf to be subjected to shelf layout analysis. Goods are displayed on the product shelf.

An image group information generation means 120 generates a first image group information item that includes the plurality of acquired images. Generation of the image group information item by the image group information generation means 120 will be described later.

The comparison means 130 makes a comparison between the first image group information item and the second image group information item. The second image group information item includes a plurality of reference images. The reference image is an image including a product shelf.

A notification means 140 gives a notification when the image group information items are different from each other as a result of the comparison by the comparison means. A case where the image group information item is different will be described later.

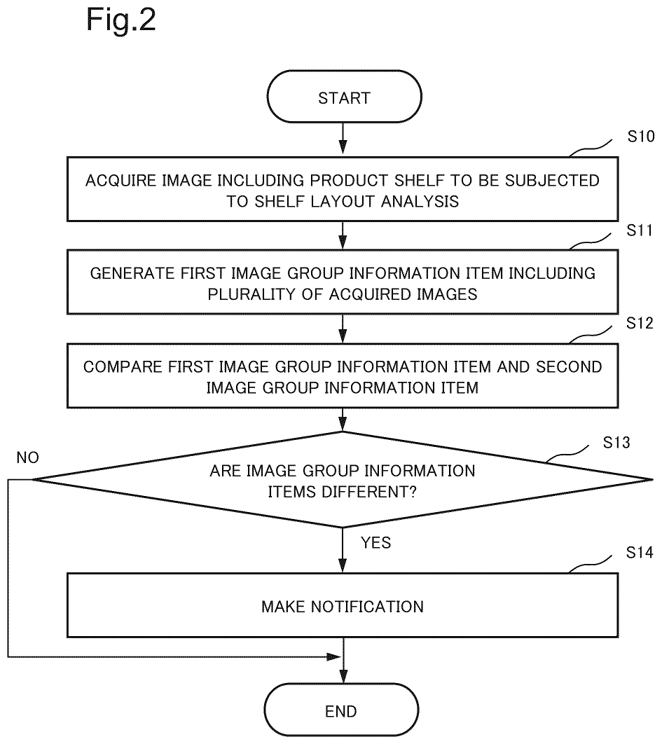

A business operation assistance method used by the business operation assistance system according to the first example embodiment will be described with reference to the drawings. FIG. 2 is a flowchart illustrating an example of an operation of the business operation assistance system according to the first example embodiment.

The image acquisition means 110 acquires an image including a product shelf to be subjected to shelf layout analysis (step S10). The image group information generation means 120 generates first image group information item including a plurality of acquired images (step S11), and the comparison means 130 compares the first image group information item with the second image group information item (step S12). Then, as a result of the comparison by the comparison means, in a case where the image group information items are different (YES in step S13), the notification means 140 makes a notification (step S14). On the other hand, as a result of the comparison by the comparison means, in a case where the image group information item matches (NO in step S13), the business operation assistance system ends the processing.

In the business operation assistance system according to the first example embodiment, the first image group information item and the second image group information item are compared, and as a result of the comparison, a notification is given in a case where the image group information items are different. As a result, since a notification is given in a case where a defect related to the captured image occurs or in a case where the layout of the product has been changed, it is possible to reduce the workload of the shelf layout analysis.

### Second Example Embodiment

In a second example embodiment, the business operation assistance system 100 of the present invention will be described in more detail. Hereinafter, the same configurations and the same operations as those of the first example embodiment will be denoted by the same reference numerals, and description of portions having overlapping descriptions will be omitted.

A configuration example of a business operation assistance system 100 according to the second example embodiment of the present invention is similar to that in FIG. 1.

The image acquisition means 110 acquires an image including a product shelf to be subjected to shelf layout analysis. Examples of the image acquired by the image acquisition means 110 include, but are not limited to, an image captured by a terminal owned by a photographer, an image captured by a patrol robot in a store, an image captured by a camera in a store, and the like.

The acquisition of the image by the image acquisition means 110 may be directly acquired from a terminal that has captured the image, or may be acquired via a network or the like. An image stored in a storage such as a cloud may be acquired.

The image acquisition means 110 may acquire an image each time an image is captured, or may collectively acquire a plurality of images. The image may be acquired on condition that a predetermined time or more has elapsed from the photographing time.

In the case of acquiring the image from the in-store camera, the image may be captured and acquired at the timing when the replenishment of the product is completed. In this way, it is possible to acquire an image of a product shelf in a state where there is no missing product or there are few missing products.

An image group information generation means 120 generates a first image group information item that includes the plurality of acquired images. The plurality of images included in the first image group information item are images including a product shelf to be subjected to shelf layout analysis. Here, the number of product shelves to be subjected to the shelf layout analysis may be one or plural.

For the product shelves to be subjected to shelf layout analysis included in the first image group information item, one first image group information item may be generated for one product shelf, or a plurality of product shelves may be included in one first image group information item.

In a case where a product shelf to be subjected to shelf layout analysis is photographed by being divided into a plurality of images, an overlapping region occurs in a part of the image. Therefore, it is conceivable to set a plurality of images including the same region in the image as the first image group information item.

In a case where a terminal owned by a photographer or an in-store patrol robot photographs a product shelf to be subjected to shelf layout analysis by dividing the product shelf into a plurality of images, the same product shelf is continuously photographed. Thereafter, the user moves to the next product shelf and starts capturing the next product shelf. Therefore, it is conceivable to set, as the first image group information item, a plurality of images whose image capturing time intervals are equal to or shorter than a predetermined time.

In addition, predetermined information may be input before or after capturing an image. For example, before or after capturing an image, information indicating a product shelf included in the image may be input, and the captured image and the input information indicating the product shelf may be stored in association with each other. The information indicating the product shelf is a number assigned to the product shelf in advance, information indicating a position where the product shelf is installed, or the like. In this case, the image group information generation means 120 can generate the first image group information item based on the information indicating the product shelf associated with the image.

The image may have shot location information. In this case, the first image group information item can be generated based on the shooting location.

The comparison means 130 makes a comparison between the first image group information item and the second image group information item. The second image group information item includes a plurality of reference images. The reference image will be described later. The first image group information item and the second image group information item include the same product shelf or the same displayed product. Here, “including the same displayed product” may be a case where some of the displayed products are the same, or may be a case where the product types of the displayed products are the same.

The comparison by the comparison means 130 may be performed on a terminal installed in a store or may be performed on a terminal owned by a photographer. The comparison by the comparison means 130 may be performed by a terminal of the head office of a product manufacturer. In addition, comparison by the comparison means 130 may be performed on a cloud. The place where the comparison by the comparison means 130 is executed is not limited thereto.

The reference image is an image suitable for shelf layout analysis. In other words, the reference image is an image obtained by photographing a product shelf to be subjected to shelf layout analysis so as not to make shelf layout analysis difficult when performing shelf layout analysis. For example, an image obtained by photographing a product shelf on which products are displayed in a display state according to the display plan without defects may be used as the reference image. Here, “without defects” indicates that there is no uncaptured portion of the product shelf to be analyzed, that the shelf is in focus, that the image is not blurred, that the necessary number of products is photographed, and the like.

The reference image may be an image used for shelf layout analysis in the past. In this case, for example, images photographed one week before, two weeks before, and three weeks before the photographing date of the image included in the first image group information item and used for the shelf layout analysis in the past are displayed as candidates of the reference image. Then, the reference image may be selected from the candidates of the reference image by the photographer or the analyst. Here, the analyst is a person who performs shelf layout analysis, and is a store clerk, an employee of a product manufacturer, or the like. The photographer and the analyst may be the same person or may be different persons.

Even if the image has been used for the shelf layout analysis in the past, the image may not be set as a candidate for the reference image in a case where the image has a defect in capturing. For example, a flag may be added to an image that has a defect in capturing, and the image to which the flag is added may not be extracted in a case where a candidate for the reference image is extracted.

The reference image may be automatically determined based on the photographing date and time of the image included in the first image group information item. For example, an image captured a predetermined number of days before the photographing date of the image included in the first image group information item and within a predetermined time before and after the photographing time of the image included in the first image group information item as a reference may be used as the reference image. By automatically determining the reference image, the workload of the shelf layout analysis can be further reduced.

As an example in which the reference image is automatically determined based on the photographing date and time of the image included in the first image group information item, a case will be considered in which an image photographed seven days before the photographing date of the image included in the first image group information item and photographed within one hour before and after the photographing time of the image included in the first image group information item is set as the second image. At this time, when the image included in the first image group information item is captured at 11:15 on Mar. 9, 2022, the image captured between 10:15 on Mar. 2, 2022 and 12:15 on Mar. 2, 2022 can be automatically determined as the reference image.

An image to be a candidate for the reference image may be extracted and presented based on the photographing date and time of the image included in the first image group information item. For example, an image captured a predetermined number of days before the photographing date of the image included in the first image group information item and within a predetermined time before and after the photographing time of the image included in the first image group information item as a reference may be used as an image to be a candidate for the reference image. In this case, the reference image may be selected by the photographer or the analyst from among the presented reference image candidates.

As a result of the comparison by the comparison means 130, in a case where it is determined that the image group information items are different, the comparison means 130 may accept the change of the reference image. As described above, it is conceivable that the reference image is changed by presenting an image to be a candidate for the reference image and changing an image selected by the photographer or the analyst as the reference image.

The notification means 140 gives a notification in a case where the image group information items are different from each other as a result of the comparison by the comparison means 130. The notification means 140 instructs a terminal owned by the photographer, a terminal installed in a store, or a terminal owned by a product manufacturer to make a notification. These terminals may function as the notification means 140, and the notification means 140 may make a notification.

Examples of the case where the image group information items are different include a case where the number of images included in the first image group information item is different from the number of reference images included in the second image group information item. In this case, the notification means 140 makes a notification.

As an example in which the image group information is different, for example, there is a case where there is a predetermined or more difference between the imaging range of the image included in the first image group information item and the imaging range of the reference image included in the second image group information item. In this case, the notification means 140 makes a notification.

In addition, as an example in which the image group information items are different, for example, there is a case where a structural difference is included between a product shelf included in the first image group information item and a product shelf included in the second image group information item. This may occur in a case where there is a layout change. In this case, the notification means 140 may make a notification. Examples of the “structural difference” include a case where information regarding the number of stages of the product shelf, the shelf width of the product shelf, the number of product shelves, the product layout, and the like included in the image group information item is different.

Examples of the notification contents by the notification means 140 include, but are not limited to, a notification indicating that the number of images to be captured is insufficient, a notification indicating that the imaging region is insufficient, and a notification indicating the possibility of a layout change.

In a case where the imaging region is insufficient, a difference between the imaging range of the image included in the first image group information item and the imaging range of the reference image included in the second image group information item may be distinguishably displayed as the notification contents by the notification means 140. In other words, information indicating that the imaging region is insufficient may be distinguishably displayed. In this case, for example, it is conceivable to display the reference image including the insufficient region. In addition, it is conceivable to distinguishable display an insufficient region on the reference image. A region that is not sufficient in the illustration or image diagram showing the product shelf may be distinguishable displayed. The image included in the first image group information item and the reference image included in the second image group information item may be displayed side by side. By distinguishable displaying the insufficient region, the region to be additionally photographed can be easily understood, and the workload of the shelf layout analysis can be reduced.

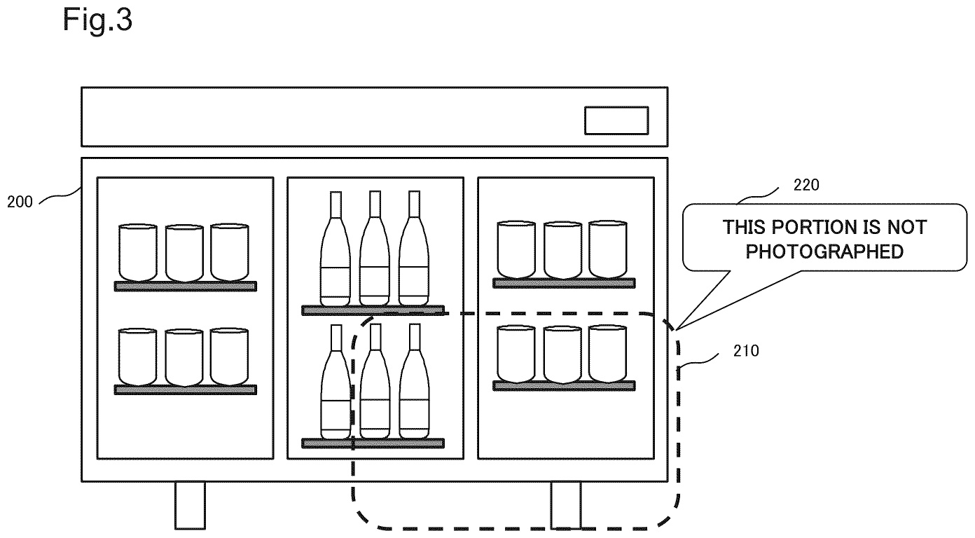

FIG. 3 illustrates an example in which, in a case where the imaging region is insufficient, the insufficient region is distinguishably displayed. In FIG. 3, an image 200 showing the entire product shelf to be analyzed is displayed. The image 200 showing the entire product shelf to be analyzed may be a reference image, or may be an illustration or an image diagram. A region 210 is displayed so as to be distinguishable by being superimposed on the image 200 showing the entire product shelf to be analyzed. The region 210 indicates an insufficient imaging region. The region 210 may be only a frame. Further, a text 220 showing that the imaging region is insufficient may be displayed.

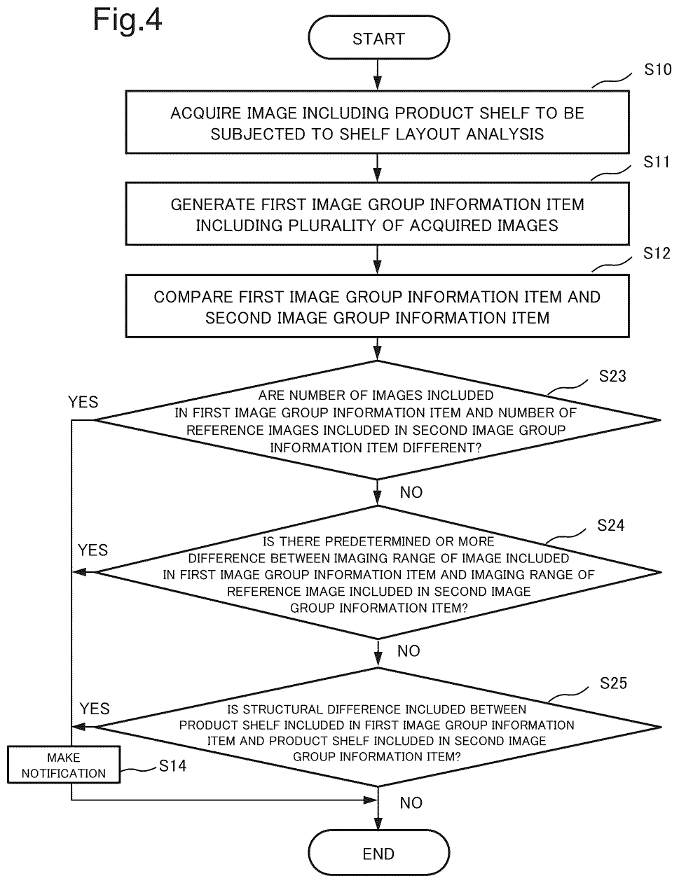

An operation of the business operation assistance system 100 according to the second example embodiment will be described with reference to the drawings. FIG. 4 is a flowchart illustrating an example of an operation of the business operation assistance system 100 according to the second example embodiment.

Since steps S10 to S12 and S14 are similar to those in FIG. 2, the description thereof is omitted. In step S23, in a case where the number of images included in the first image group information item is different from the number of reference images included in the second image group information item (YES in step S23), the notification means 140 makes a notification (step S14). On the other hand, in a case where the number of images included in the first image group information item is the same as the number of reference images included in the second image group information item (NO in step S23), the process proceeds to step S24.

In step S24, in a case where there is a predetermined or more difference between the imaging range of the image included in the first image group information item and the imaging range of the reference image included in the second image group information item (YES in step S24), the notification means 140 makes a notification (step S14). On the other hand, in a case where there is no predetermined or more difference between the imaging range of the image included in the first image group information item and the imaging range of the reference image included in the second image group information item (NO in step S24), the process proceeds to step S25.

In step S25, in a case where a structural difference is included between the product shelf included in the first image group information item and the product shelf included in the second image group information item (YES in step S25), the notification means 140 makes a notification (step S14). On the other hand, in a case where there is no structural difference between the product shelf included in the first image group information item and the product shelf included in the second image group information item (NO in step S25), the business operation assistance system ends the process.

However, it is not necessary to perform all of steps S23 to S25. Only one of steps S23 to S25 may be performed. For example, only step S24 may be performed after step S12. In this case, if YES in step S24, the business operation assistance system makes a notification, and if NO in step S24, the business operation assistance system ends the process. Only any two of steps S23 to S25 may be performed. For example, only step S23 and step S24 may be performed after step S12. In this case, if YES in step S23 or YES in step S24, the business operation assistance system makes a notification, and if NO in step S23 and NO in step S24, the business operation assistance system ends the process.

The processing order of steps S23 to S25 may be switched. Further, steps S23 to S25 may be processed in parallel.

In a case where YES in step S23, step S24 may be executed. In this case, if NO in step S24, no notification is made. With such a configuration, notification is not given in a case where the number of images included in the image group is different, but the imaging ranges coincide with each other. Furthermore, in a case where step S23 and step S24 are processed in parallel, if step S24 is NO, notification may not be made even if step S23 is YES.

In the business operation assistance system according to the second example embodiment, the first image group information item and the second image group information item are compared, and as a result of the comparison, a notification is given in a case where the image group information items are different. As a result, since a notification is given in a case where a defect related to the captured image occurs or in a case where the layout of the product has been changed, it is possible to reduce the workload of the shelf layout analysis.

The notification is made in a case where the number of images included in the first image group information item is different from the number of reference images included in the second image group information item. As a result, it is possible to know the possibility that there is a defect related to the image included in the first image group information item, and it is possible to reduce the workload of the shelf layout analysis.

In a case where there is a predetermined or more difference between the imaging range of the image included in the first image group information item and the imaging range of the reference image included in the second image group information item, a notification is made. As a result, it is possible to know the possibility that there is a defect related to the image included in the first image group information item, and it is possible to reduce the workload of the shelf layout analysis.

In a case where a structural difference is included between the product shelf included in the first image group information item and the product shelf included in the second image group information item, a notification is made. As a result, it is possible to know the possibility that there is a change in the display layout of the product, and it is possible to reduce the workload of the shelf layout analysis.

### Modification of Second Example Embodiment

As a modification of the second example embodiment, the notification destination by the notification means 140 is changed. A configuration example of a business operation assistance system 100 according to a modification of the second example embodiment is similar to that in FIG. 1. Here, a notification means 140 that operates differently from the second example embodiment will be described.

The notification means 140 changes the notification destination based on the result of the comparison by the comparison means. For example, in a case where the number of images included in the first image group information item is different from the number of reference images included in the second image group information item, or in a case where the imaging range of the image included in the first image group information item is different from the imaging range of the reference image included in the second image group information item, at least the photographer is notified. On the other hand, in a case where a structural difference is included between the product shelf included in the first image group information item and the product shelf included in the second image group information item, at least the analyst is notified.

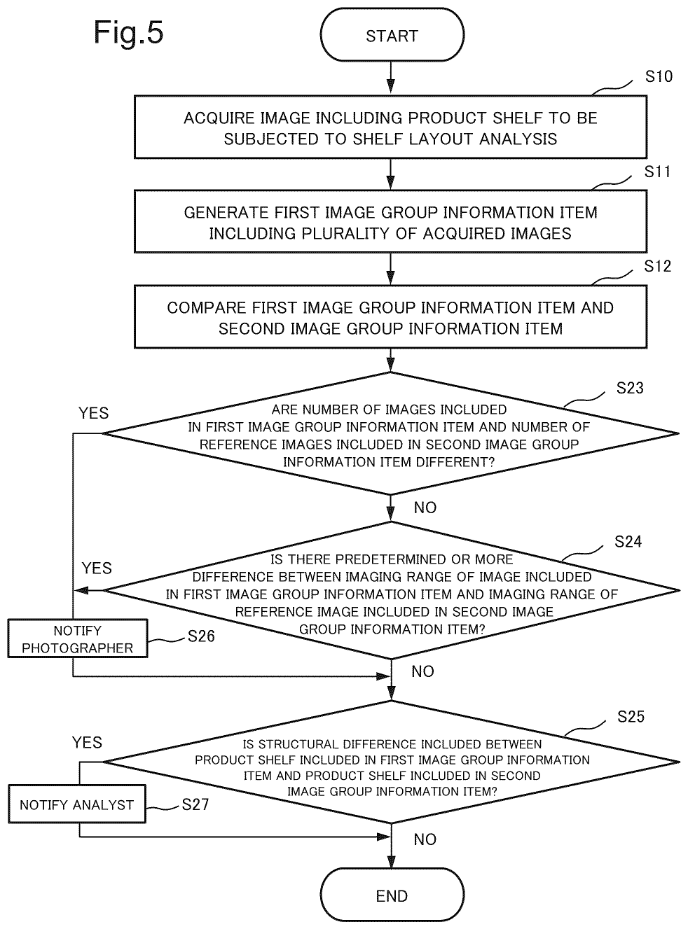

An operation of the business operation assistance system 100 according to a modification of the second example embodiment will be described with reference to the drawings. FIG. 5 is a flowchart illustrating an example of an operation of the business operation assistance system 100 according to a modification of the second example embodiment.

Since steps S10 to S12 are similar to those in FIG. 4, description thereof is omitted. In the case of YES in step S23, the notification means 140 makes a notification to at least the photographer (step S26), and the process proceeds to step S25. In the case of NO in step S23, the process proceeds to step S24.

In the case of YES in step S24, the notification means 140 makes a notification to at least the photographer (step S26), and the process proceeds to step S25. In the case of NO in step S24, the process proceeds to step S25.

In the case of YES in step S25, the notification means 140 makes a notification to at least the analyst (step S27), the business operation assistance system ends the process. On the other hand, in the case of NO in step S25, the business operation assistance system ends the process.

After notifying the photographer in S26, the business operation assistance system may end the process without proceeding to the processing in S25.

It is not necessary to perform all of steps S23 to S25. Only one of steps S23 to S25 may be performed. For example, only step S24 may be performed after step S12. In this case, in the case of YES in step S24, at least the photographer is notified, and the business operation assistance system ends the process. On the other hand, in the case of NO in step S24, the business operation assistance system ends the process. Only any two of steps S23 to S25 may be performed. For example, only step S23 and step S24 may be performed after step S12. In this case, in the case of YES in step S23 or YES in step S24, at least the photographer is notified, and the business operation assistance system ends the process. On the other hand, in the case of NO in step S23 and NO in step S24, the business operation assistance system ends the process.

The processing order of steps S23 to S25 may be switched. Further, steps S23 to S25 may be processed in parallel.

In the business operation assistance system according to a modification of the second example embodiment, the first image group information item and the second image group information item are compared, and as a result of the comparison, a notification is given in a case where the image group information items are different. As a result, since a notification is given in a case where a defect related to the captured image occurs or in a case where the layout of the product has been changed, it is possible to reduce the workload of the shelf layout analysis.

The notification destination is changed based on the result of the comparison by the comparison means. As a result, it is possible to notify an appropriate notification destination, and it is possible to reduce the workload of the shelf layout analysis.

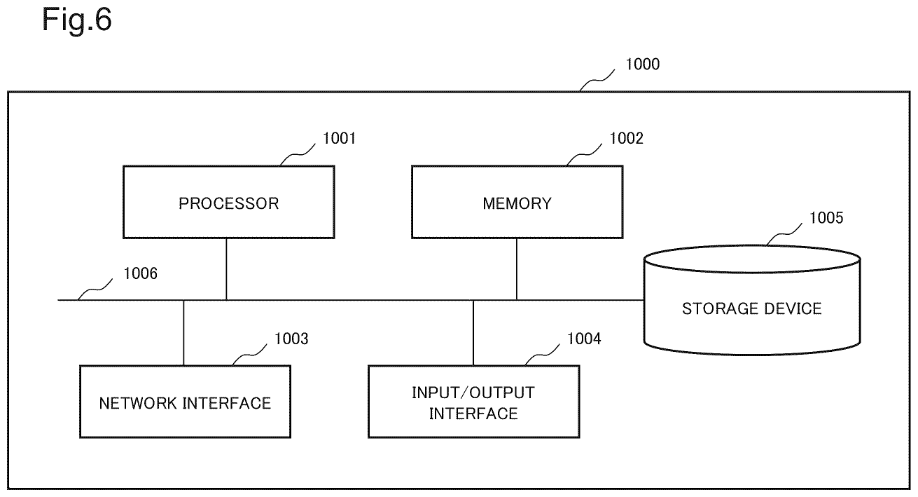

In each example embodiment of the present disclosure, each component of each business operation assistance system indicates a block in units of function. Some or all of the components in each business operation assistance system are implemented by a combination of hardware and a program. FIG. 6 is a block diagram illustrating a hardware configuration of an information processing device 1000 that can configure each component in each example embodiment.

The information processing device 1000 includes a processor 1001, a memory 1002, a network interface 1003, an input/output interface 1004, and a storage device 1005, and the components of the information processing device 1000 are communicably connected by a bus 1006.

The processor 1001 is implemented by a central processing unit (CPU), a graphics processing unit (GPU), or the like.

The memory 1002 is a main storage device implemented by a random access memory (RAM) or the like.

The network interface 1003 is an interface for connecting to a network. Here, the network is a local area network (LAN) or a wide area network (WAN).

The input/output interface 1004 is an interface for connecting to various input/output devices.

The storage device 1005 is an auxiliary storage device implemented by a hard disk drive (HDD), a solid state drive (SSD), a memory card, a read only memory (ROM), or the like. The storage device 1005 may store a program for achieving the function of each component.

The processor 1001 implements the function of each component by reading a program stored in the storage device 1005 into the memory 1002 and executing the program. The program may be supplied from a network via the network interface 1003. In addition, the program is stored in advance in a storage medium (not illustrated), and may be supplied by reading the program.

This program can display the processing result including the intermediate state for each stage via the display device as necessary, or can communicate with the outside via the network interface 1003. This program can be recorded in a computer-readable (non-transitory) recording medium.

The present disclosure is not limited to the above-described example embodiments, and various modifications can be made, and example embodiments obtained by appropriately combining configurations, operations, and processes disclosed in different example embodiments are also included in the technical scope of the present disclosure.

The present disclosure is not limited to the above-described example embodiments. That is, the present invention can apply various aspects that can be understood by those of ordinary skill in the art without departing from the spirit and scope of the present disclosure.

### Reference Signs List

100 business operation assistance system
110 image acquisition means
120 image group information generation means
130 comparison means
140 notification means
1000 information processing device
1001 processor
1002 memory
1003 network interface
1004 input/output interface
1005 storage device
1006 bus

What is claimed is:

1. A business operation assistance system comprising:
one or more memories storing instructions; and
one or more processors configured to execute the instructions to:
acquire an image including a product shelf;
generate a first image group information item including a plurality of the images;
compare the first image group information item with a second image group information item including a reference image; and
make a notification in a case where the image group information items are different as a result of comparison by the comparison means.

2. The business operation assistance system according to claim 1, wherein
a case where the image group information items are different includes at least one of cases:
(a) where a number of the images included in the first image group information item is different from a number of the reference images included in the second image group information item;
(b) where there is a predetermined or more difference between an imaging range of the image included in the first image group information item and an imaging range of the reference image included in the second image group information item; and
(c) where there is a structural difference between the product shelf included in the first image group information item and the product shelf included in the second image group information item.

3. The business operation assistance system according to claim 2, wherein the one or more processors configured to execute the instructions to:
notify at least a photographer in the case (a) where a number of the images included in the first image group information item is different from a number of the reference images included in the second image group information item, or in the case (b) where there is a predetermined or more difference between an imaging range of the image included in the first image group information item and an imaging range of the reference image included in the second image group information item; and
notify at least an analyst in the case (c) where there is a structural difference between the product shelf included in the first image group information item and the product shelf included in the second image group information item.

4. The business operation assistance system according to claim 2, wherein the one or more processors configured to execute the instructions to:
in the case (b) where there is a predetermined or more difference between an imaging range of the image included in the first image group information item and an imaging range of the reference image included in the second image group information item, distinguishably notify a difference between an imaging range of the image included in the first image group information item and an imaging range of the reference image included in the second image group information item.

5. The business operation assistance system according to claim 1, wherein
the reference image is determined based on a photographing date and time of the image.

6. (canceled)

7. A business operation assistance method comprising:
acquiring an image including a product shelf;
generating a first image group information item including a plurality of the images;
comparing the first image group information item with a second image group information item including a reference image; and
making a notification in a case where the image group information items are different as a result of the comparing.

8. A computer-readable storage medium storing a program for causing a computer to execute:
acquiring an image including a product shelf;
generating a first image group information item including a plurality of the images;
comparing the first image group information item with a second image group information item including a reference image; and
making a notification in a case where the image group information items are different as a result of the comparing.
